(19) United States
(12) Patent Application Publication
(10) Pub. No.: US 2009/0132798 A1
(43) Pub. Date: May 21, 2009

(54) ELECTRONIC DEVICE AND METHOD FOR RESUMING FROM SUSPEND-TO-MEMORY STATE THEREOF

(75) Inventor: Ting-Kuo Kao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/207,511

(22) Filed: Sep. 10, 2008

(30) Foreign Application Priority Data
Nov. 16, 2007 (TW) 96143376

(51) Int. Cl. G06F 15/177; G06F 3/06; G06F 13/00; G06F 1/26

(52) U.S. Cl. 713/2; 710/301; 710/13; 713/300

(57) ABSTRACT

An electronic device and a method for resuming from a suspend-to-memory (S3) state thereof are provided. The electronic device comprises a detecting circuit, a storage unit and a booting module. The detecting circuit outputs a state change value when detecting a state variation of any non-hot plug device. The storage unit is used for storing the state change value output from the detecting circuit. When the electronic device is resumed from the S3 state to the working state, a normal booting procedure is performed on the electronic device if the state change value is detected by the booting module.

### CROSS-REFERENCE TO RELATED APPLICATION

This application claims the priority benefit of Taiwan application serial no. 96143376, filed on Nov. 16, 2007. The entirety of the above-mentioned patent application is hereby incorporated by reference herein and made a part of specification.

### BACKGROUND OF THE INVENTION

1. Field of the Invention

The present invention relates to an electronic device and a method for resuming the electronic device from a suspend-to-memory state. More particularly, the present invention relates to a method for resuming an electronic device from a suspend-to-memory state, which may support adding or removing of non-hot plug devices.

2. Description of Related Art

In an advanced configuration and power interface (ACPI) standard, besides a working state S0, states of a computer system further include a sleeping mode with less power consumption. Based on different power consumptions and response speeds, the sleeping mode can be classified into several grades of S1, S3, S4 and S5. Under the S1 (power on suspend) state, only a screen of the computer system is turned off, so that the computer system can be quickly resumed back to the working state. Under the so-called suspend to memory (S3) state, besides a memory and a controller thereof require power to maintain data, power for all other devices is cut off. Under the S4 (suspend to disk) state, data within the memory is stored into a hard disk, so that power supply for the memory is not required. The so-called S5 state is a shutdown state, by which only a little stand-by power is maintained for the computer system.

It is obvious that the further the power-saving mode is, the longer time required to resume the working state. Further, in the above sleeping modes, the S5 state is the most power-saving state, though when the computer system is resumed from the S5 state to the working state, a booting self-test is performed by a basic input output system (BIOS), so as to initialize and scan peripheral hardware devices, and write related setting values to the peripheral hardware devices until corresponding drivers are loaded. The aforementioned operations lead to a very long booting time of the computer system.

Comparatively, since before the computer system enters the S3 state, the present utilization information (including various settings, drivers, or states of presently executed application programs, etc.) is recorded in a page file by an operating system, and the page file is stored into the memory. When the computer system is resumed from the power-saving mode S3 to the working state S0, only basic chip settings are executed via the BIOS, domination of the computer system is then transferred to the operating system, so as to resume the computer system to an original state according to data of the page file. Therefore, in case that no hardware is required to be initialized, scanned and detected, the working state can be quickly resumed. Since when the computer system is resumed from the S3 state to the working state S0, the BIOS does not scan the peripheral hardware devices, so that if any non-hot plug device is added to or removed from the computer system during the S3 state, when the computer system is resumed to the working state S0, actual states of the hardware devices then disaccord to the data recorded in the page file, which may lead to non-operation of the computer system, even damage of the computer system or the hardware devices. Namely, if the computer system is set to the S3 state for quick booting, no non-hot plug device can be added or removed from the computer system under such state.

### SUMMARY OF THE INVENTION

Accordingly, the present invention is directed to an electronic device (or a computer system), which allows adding or removing of non-hot plug devices when the electronic apparatus enters a suspend to memory (S3) state, and failure of resuming a working state due to non-operation and damage of the electronic device can be avoided, so that utilization convenience of the computer system is improved.

The present invention is directed to a method for resuming an electronic device from a suspend-to-memory state, by which when the electronic device is resumed from the suspend-to-memory state to the working state, whether any non-hot plug device is added or removed during the suspend-to-memory state is first judged, and a different resuming procedure is executed according to a judgement result thereof, so as to avoid failure of booting the computer system caused by adding or removing of non-hot plug devices.

The present invention provides an electronic device having a working state and a suspend-to-memory state, and connecting at least one non-hot plug device. The electronic device includes a detecting circuit, a storage unit and a booting module. The detecting circuit outputs a state change value when detecting a state variation of any non-hot plug device. The storage unit receives and stores the state change value. When the electronic device is resumed from the suspend-to-memory state to the working state, a normal booting procedure is performed on the electronic device if the booting module detects the state change value.

The state variation of the non-hot plug device represents one of situations that the non-hot plug device is installed on the electronic device and the non-hot plug device is removed from the electronic device. If the booting module cannot detect the state change value, the electronic device then executes a memory resuming procedure. The normal booting procedure includes rescanning the non-hot plug devices, and the memory resuming procedure includes resuming the electronic device from the suspend-to-memory state to the working state based on a parameter data stored in a memory.

In an embodiment of the present invention, the detecting circuit further includes at least one detecting unit and a logic gate. Each of the detecting units is used for detecting one of the non-hot plug devices, and correspondingly outputting a signal if there is any state variation. The logic gate receives the signal and output the state change value. The logic gate can be an NAND gate. The detecting units are respectively disposed to a plurality of non-hot plug device slots, for controlling outputting of the signal according to electrical connections between the non-hot plug devices and the non-hot plug device slots.

In an embodiment of the present invention, the non-hot plug device includes a memory, and the electronic device further includes a memory power switch. The memory power switch is connected to the memory, the detecting circuit and a power supply, and is used for cutting off the power supplied to the memory when the detecting circuit detects the memory is added or removed.

In an embodiment of the present invention, the storage unit is a south bridge chip register or a super I/O chip register. The booting module includes a BIOS and an operating system. The non-hot plug device can be an integrated drive electronics (IDE) device, a peripheral component interconnect (PCI) device or a PS2 device. According to another aspect, the present invention provides a method for resuming an electronic device, the electronic device has at least one non-hot plug device. The method includes following steps. First, a state change value is generated when a state variation of any non-hot plug device is detected. Next, the state change value is stored. Finally, when the electronic device is resumed from the suspend-to-memory state to the working state, a normal booting procedure is performed on the electronic device if the state change value is detected.

In the present invention, when the computer system is in the suspend-to-memory state, whether any non-hot plug device is added or removed is recorded, so that when the computer system is about to be resumed to the working state, whether the resuming operation is performed based the memory resuming procedure or the conventional booting process is judge according to the recorded result. Therefore, as long as no non-hot plug device is added or removed, the computer system can be resumed to the working state according to the memory resuming procedure, so that booting speed of the computer system is increased.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an electronic device according to an embodiment of the present invention.

FIG. 2 is a flowchart illustrating a method for resuming an electronic device from a suspend-to-memory state.

### DESCRIPTION OF EMBODIMENTS

Under a present computer system structure, resuming from a suspend-to-memory (S3) state to a working state is both a power saving and quick booting method. However, the present computer system does not support adding and removing of non-hot plug devices under the S3 state. Therefore, a mechanism of recording information of adding or removing the non-hot plug device under the S3 state is provided, so that when the electronic device (computer system) is about to be resumed from the S3 state to the working state S0, booting procedure of the electronic device can be selected according to a state variation of the detected non-hot plug device, and in case that no non-hot plug device is renewed, a memory resuming procedure can be directly applied to increase a booting speed of the computer system, while in case that the non-hot plug device is renewed, no-operation of the computer system can be avoided. Accordingly, the present invention provides an electronic device and a method for resuming from the S3 state thereof according to the above aspects. To fully convey the spirit of the present invention, embodiments are provided below for detail description.

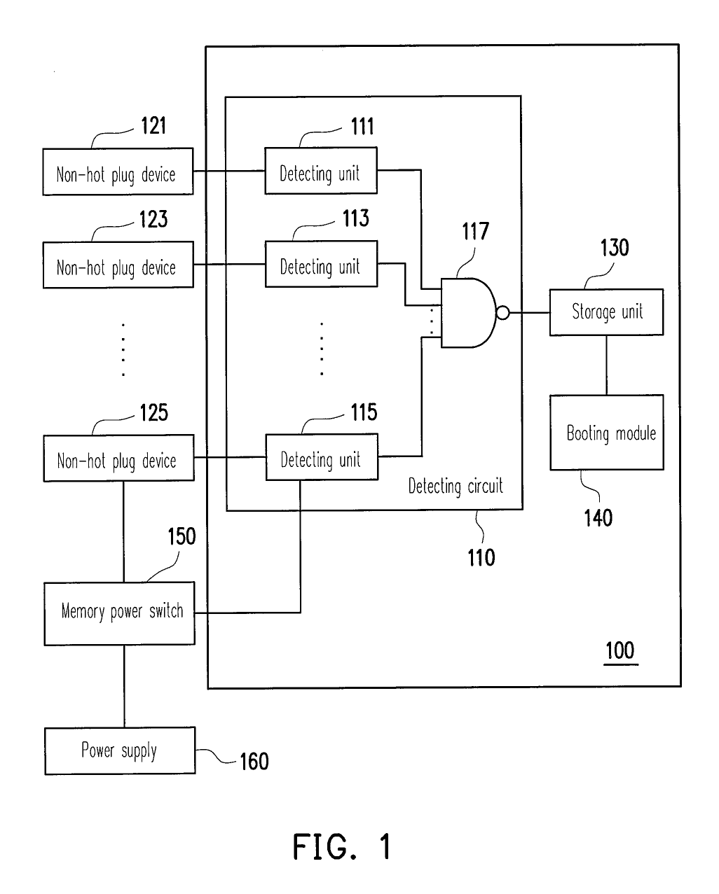

FIG. 1 is a block diagram illustrating an electronic device according to an embodiment of the present invention. Referring to FIG. 1, the electronic device 100 can be applied to a computer system (not shown) for resuming the computer system from the S3 state to the working state S0. The electronic device 100 includes a detecting circuit 110, a storage unit 130 and a booting module 140. In the present embodiment, the computer system may have a plurality of non-hot plug devices (for example, a non-hot plug device 121, a non-hot plug device 123 and a non-hot plug device 125, etc.), and the non-hot plug device can be a hard disk, a PS2 mouse or a display card, etc. If classified according to link interfaces between the non-hot plug device and the computer system, the non-hot plug device can be an IDE device, a PCI device or a PS2 device, etc., which is not limited by the present invention. The detecting circuit 110 is used for detecting state variations of the aforementioned non-hot plug devices, and is coupled to the storage unit 130 for outputting state change values to the storage unit 130.

Further, the detecting circuit 110 includes a plurality of detecting units (for example, a detecting unit 111, a detecting unit 113 and a detecting unit 115) and a logic gate 117. In the present embodiment, each of the detecting units is used for detecting a state of a different non-hot plug device, and outputs a corresponding signal when the state of the corresponding non-hot plug device is renewed. For example, when the detecting unit 111 detects that the non-hot plug device 121 is added or removed, the logic gate 117 then outputs a signal representing that the non-hot plug device 121 is renewed.

In an embodiment, the detecting units of the detecting circuit 110 are for example, disposed on non-hot plug device slots of a motherboard. Taking the PCI slots as an example, the detecting unit is disposed on each of the PCI slots of the motherboard of the computer system, and the detecting unit may detect a state of the PCI device according to a connecting relation between pins of the PCI slot and the PCI device, and output the corresponding signal. For example, assuming when the PCI device is installed in the computer system, the detecting unit outputs a high level signal. Then, when the PCI device (for example, a display card having a PCI interface) originally plugged in the PCI slot is removed, the detecting unit changes the output signal to a low level.

In another embodiment, all of the PS2 slots of the computer system are equipped with the detecting units, and the detecting unit judges whether a PS2 device (for example, a PS2 mouse) is added or removed according to for example, a signal value of an arbitrary pin of the PS2 slot. It should be noted that the aforementioned detecting unit is only an example, and any equivalent circuit that can detect the state of the non-hot plug device, and output the corresponding signal according to a renew information of the non-hot plug device can be regarded as the detecting unit, which is not limited by the present invention.

As shown in FIG. 1, all signals output from the detecting units are together transmitted to an input terminal of the logic gate 117. The logic gate 117 can be for example, an NAND gate. After the logic gate 117 receives the aforementioned signals, the logic gate 117 generates a corresponding state change value according to all of the received signals, and transmits the state change value to the storage unit 130 via an output terminal thereof. The state change value output by the logic gate 117 corresponds to the states of all of the non-hot plug devices. In other words, as long as the state of one of the non-hot plug device is varied, output signal of the corresponding detecting unit is changed, and accordingly the state change value output by the logic gate 117 is changed. Namely, when the state of any non-hot plug device is changed, the state change value stored in the storage unit 130 is changed accordingly. In the present embodiment, the storage unit 130 used for storing the state change value is for example a south bridge chip register or a super I/O chip register, which is not limited by the present invention.

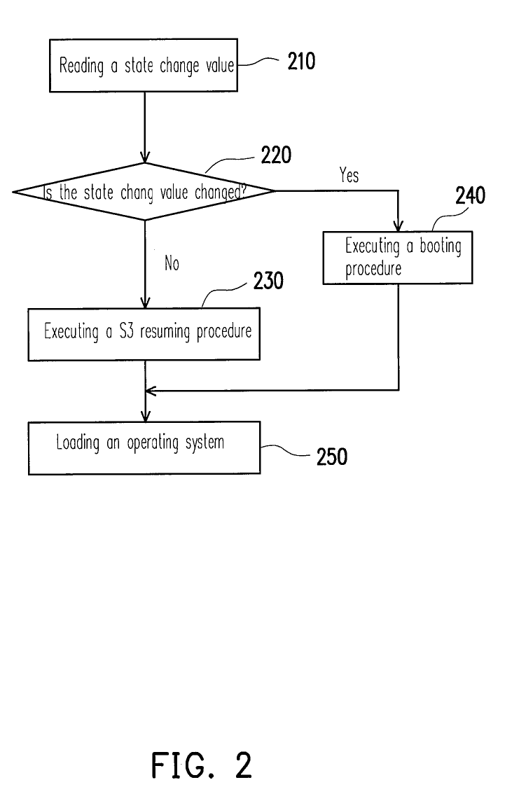

The booting module 140 is connected to the storage unit 130 for executing a different procedure according to variations of the state change value, so as to resume the computer system from the S3 state to the working state. The booting module 140 includes for example, a BIOS and an operating system. In the following embodiment, how the booting module 140 boots the computer system according to the state change value is described in detail. Referring to FIG. 2, when a power button is pressed for resuming the computer system from the S3 state to the working state, in step 210, the booting module 140 reads the state change value from the storage unit 130 via the BIOS.

Next, in step 220, whether the state change value is changed is judged, or assuming there is a predetermined value, and whether the state change value which is different from the predetermined value is received is judged. If the state change value maintains unchanged (or is the predetermined value), it represents there is no non-hot plug device is added or removed from the computer system during the S3 state. Therefore, in step 230, the booting module 140 may execute a memory resuming procedure via the operating system, and reload a parameter data (i.e. a page file) that stored in the memory before the computer system enters the S3 state. By such means, the computer system can be quickly resumed from the S3 state to the working state.

However, if the booting module 140 judges that the state change value is varied, it represents some non-hot plug devices are added or removed from the computer system during the S3 state. To successfully boot the computer system and utilize the added non-hot plug devices, in step 240, the booting module 140 executes a normal booting procedure. Namely, the hardware devices (including all of the non-hot plug devices) of the computer system are rescanned and reset via a power on self test (POST) procedure. By such means, the added devices are initialized, and can operate normally.

Last, in step 250, the operating system is loaded into the computer system to complete the whole resuming procedure, so that the computer system can enter the working state, and is available for being operated. Since most of the users usually do not add or remove the non-hot plug devices each time before utilization of the computer system, in such case, the booting module 140 then executes the memory resuming procedure to resume the computer system to the wording state. Compared to the conventional booting procedure, time spent for the memory resuming procedure is relatively less, so that booting speed of the computer system can be increased, and accordingly utilization efficiency thereof is improved. Besides, the user may still add or remove the non-hot plug device under the S3 state according to actual requirements, and inconvenience of the conventional technique that the non-hot plug device cannot be renewed under the S3 state can be avoided.

It should be noted that in the computer system, the memory (for example, a dynamic random access memory (DRAM)) used for storing the page file is also the non-hot plug device. When the computer system is in the S3 state, the memory has to be powered in order to maintain the data stored therein. To avoid damage of the memory caused by arbitrary plugging/unplugging of the powered memory, in the present embodiment, the power supplied to the memory is specifically managed. Referring to FIG. 1, for simplicity's sake, in the present embodiment, the non-hot plug device 125 is assumed to be a DRAM. In the electronic device 100, a memory power switch 150 is coupled to the non-hot plug device 125 (i.e. the DRAM), the detecting unit 115 corresponding to the DRAM and a power supply 160 which supplies power to the DRAM, respectively. When the detecting unit 115 detects that the DRAM is added or removed, the memory power switch 150 originally connected to the DRAM and the power supply 160 is cut off, so as to stop supplying power to the DRAM, and protect the DRAM from damaging.

In another embodiment, a power button of the computer system can be set to have a function of entering the S3 state via a software, so that each time the power button is pressed, the computer system can directly enter the S3 state. A renewing state of the non-hot plug device under the S3 state can be detected by a memory resuming system, and when the power button is again pressed for booting the computer system, whether the computer system is booted according to the memory resuming procedure or the booting procedure is judged. Therefore, in case that no non-hot plug device is added or removed, booting speed of the computer system can be greatly improved.

In summary, the electronic device and the method for resuming from the S3 state thereof have at least the following advantages:

1. A judgement mechanism is executed when booting the computer system, so as to confirm whether the non-hot plug device is renewed. If the non-hot plug device is added or removed, the conventional booting procedure is applied to boot the computer system. By such means, the non-hot plug device can still be renewed under the S3 state, and no-operation of the computer system during booting can be avoided, so that utilization flexibility of the computer system is increased.

2. In case that there is no non-hot plug device is added or removed, the computer system can be quickly resumed to the working state according to the Memory resuming procedure, so that efficiency of booting the computer system can be improved, and utilization convenience thereof is increased.

3. A mechanism for protecting the memory under the S3 state is provided, by which the power supply can be cut off during adding or removing of the memory, so as to prevent damaging of the memory caused by plugging/unplugging of the powered memory.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, having a working state and a suspend-to-memory state, and connected to at least one non-hot plug device, comprising:
a detecting circuit, for outputting a state change value when detecting a state variation of any non-hot plug device;
a storage unit, for receiving and storing the state change value; and
a booting module, coupled to the storage unit, wherein when the electronic device is resumed from the suspend-to-memory state to the working state, the electronic device executes a normal booting procedure if the booting module detects the state change value.

2. The electronic device as claimed in claim 1, wherein if the booting module does not detect the state change value, the electronic device executes a memory resuming procedure.

3. The electronic device as claimed in claim 1, wherein the state variation of the non-hot plug device represents one of situations that the non-hot plug device is installed on the electronic device or the non-hot plug device is removed from the electronic device.

4. The electronic device as claimed in claim 1, wherein the normal booting procedure comprises rescanning the non-hot plug devices.

5. The electronic device as claimed in claim 2, wherein the memory resuming procedure comprises resuming the electronic device from the suspend-to-memory state to the working state based on a parameter data stored in a memory.

6. The electronic device as claimed in claim 1, wherein the detecting circuit further comprises:
at least one detecting unit, for detecting one of the non-hot plug devices, and correspondingly outputting a signal if there is any state variation; and
a logic gate, for receiving the signals and output the state change value.

7. The electronic device as claimed in claim 6, wherein the logic gate is an NAND gate.

8. The electronic device as claimed in claim 6, wherein the detecting units are respectively disposed to a plurality of non-hot plug device slots, for controlling outputting of the signal according to electrical connections between the non-hot plug devices and the non-hot plug device slots.

9. The electronic device as claimed in claim 1, wherein the non-hot plug device comprises a memory.

10. The electronic device as claimed in claim 9, further comprising:
a memory power switch, coupled to the memory, the detecting circuit and a power supply, for cutting off the power supplied to the memory when the detecting circuit detects the memory is added or removed.

11. The electronic device as claimed in claim 1, wherein the storage unit is a south bridge chip register or a super I/O chip register.

12. The electronic device as claimed in claim 1, wherein the booting module comprises a basic input output system (BIOS) and an operating system.

13. The electronic device as claimed in claim 1, wherein the non-hot plug device is one of an integrated drive electronics (IDE) device, a peripheral component interconnect (PCI) device and a PS2 device, or a combination thereof.

14. The electronic device as claimed in claim 1, wherein a button controls resuming of the electronic device from the suspend-to-memory state to the working state.

15. A method for resuming an electronic device, wherein the electronic device has at least one non-hot plug device, the method comprising:
generating a state change value when detecting a state variation of any non-hot plug device;
storing the state change value; and
when the electronic device is resumed from a suspend-to-memory state to a working state, the electronic device executes a normal booting procedure if the state change value is detected.

16. The method for resuming an electronic device from a suspend-to-memory state as claimed in claim 15, wherein executing the normal booting procedure comprises rescanning the non-hot plug devices.

17. The method for resuming an electronic device from a suspend-to-memory state as claimed in claim 15, wherein if the state change value is not detected, the electronic device executes a memory resuming procedure.

18. The method for resuming an electronic device from a suspend-to-memory state as claimed in claim 17, wherein the memory resuming procedure comprises resuming from the suspend-to-memory state to the working state based on a parameter data stored in a memory.

19. The method for resuming an electronic device from a suspend-to-memory state as claimed in claim 15, wherein detecting the state variation of any non-hot plug device comprises generating the state change value when each of the non-hot plug devices is added to or removed from a corresponding non-hot plug device slot.

20. The method for resuming an electronic device from a suspend-to-memory state as claimed in claim 15, wherein the non-hot plug device comprises a memory.

21. The method for resuming an electronic device from a suspend-to-memory state as claimed in claim 20, further comprising:
cutting of a power supplied to the memory when the memory is added or removed.

22. The method for resuming an electronic device from a S3 state as claimed in claim 15, wherein storing the state change value comprises storing the state change value in a south bridge chip register or a super I/O chip register.
